(19) United States
(12) Patent Application Publication
(10) Pub. No.: US 2017/0222955 A1
(43) Pub. Date: Aug. 3, 2017

(54) METHOD, SERVER AND BASEBOARD MANAGEMENT CONTROLLER FOR INTERRUPTING A PACKET STORM

(71) Applicant: MITAC COMPUTING TECHNOLOGY CORPORATION, Taoyuan City (TW)

(72) Inventor: Ming-I KUO, Taoyuan City (TW)

(21) Appl. No.: 15/413,930

(22) Filed: Jan. 24, 2017

(30) Foreign Application Priority Data
Jan. 28, 2016 (TW) 105102615

(51) Int. Cl. H04L 12/931; H04L 12/861; H04L 29/06

(52) U.S. Cl. CPC H04L 49/505; H04L 69/22; H04L 49/9047; H04L 49/201; H04L 49/501; H04L 69/28

(57) ABSTRACT

A method for interrupting a packet storm in a server is implemented by a baseboard management controller (BMC) included in the server and includes the steps of: assigning a setting value included in firmware of the BMC to a first value so as to enable receipt of specific packets from a network, the specific packets being transmitted using a specific routing scheme; determining whether a packet storm has occurred according to a number of the specific packets that are received; and assigning the setting value to a second value so as to disable receipt of the specific packets when it is determined that the packet storm has occurred.

### CROSS-REFRENCE TO RELATED APPLICATION

This application claims priority of Taiwanese Patent Application No. 105102615, filed on Jan. 28, 2016.

### FIELD

The disclosure relates to a method, a server and a baseboard management controller for interrupting a packet storm.

### BACKGROUND

A server communicating with a number of remote clients may be able to monitor communications via a network, using a baseboard management controller (BMC) included therein. The BMC is typically employed by the server to implement monitoring of one or more remotely connected hosts via a network.

In order for the BMC to be able to communicate with a specific remote client, the BMC may send an address resolution protocol (ARP) request in a packet so as to locate the specific remote client, and map an Internet protocol (IP) address of the specific remote client to a physical address (e.g., a media access control (MAC) address) of the specific remote client.

However, when a large number of ARP packets is transmitted to the BMC during a short time period via specific communication methods such as multicast, broadcast, etc., a phenomenon called an ARP storm (also known as a packet storm) may occur. In such a phenomenon, packets may flow into the server at a fast rate, consuming resources and subsequently overloading a queue buffer of the BMC, which may not be able to process all the incoming packets. This may cause the undesired effect where other packets received in the same time period (e.g., data packets received via Dynamic Host Configuration Protocol (DHCP)) cannot be processed by the BMC and are therefore dropped.

Other effects of the ARP storm may include an increased loading applied to a central processing unit (CPU) of the BMC, resulting in compromises to other scheduled tasks and/or issues with accesses to the memories, rendering the BMC non-operational.

### SUMMARY

One object of the disclosure is to provide a method for interrupting a packet storm in a server.

According to one embodiment of the disclosure, the method may be implemented by a baseboard management controller (BMC) included in the server and includes the steps of:

a) assigning a setting value included in firmware of the BMC regarding allowance for receipt of specific packets to a first value so as to enable receipt of specific packets from a network, the specific packets being transmitted using a specific routing scheme;

b) determining whether a packet storm has occurred according to a number of the specific packets that are received after step a); and

c) assigning the setting value to a second value so as to disable receipt of the specific packets when it is determined that the packet storm has occurre

Another object of the disclosure is to provide a baseboard management controller (BMC) that is programmed to perform the above-mentioned method.

According to one embodiment of the disclosure, the baseboard management controller (BMC) is included in a server and includes a connection port for receiving network packets from a network, a network queue buffer coupled to the connection port for storing the network packets therein, and a processor coupled to the network queue buffer. The processor is programmed to enable or disable receipt of specific packet according to a setting value included in firmware of the BMC regarding allowance for receipt of specific packets, and to perform the steps of:

assigning a setting value regarding allowance for receipt of specific packets to a first value so as to enable receipt of specific packets via the connection port from the network, the specific packets being transmitted using a specific routing scheme;

determining whether a packet storm has occurred according to a number of the specific packets that are received by the server via the connection port; and

assigning the setting value to a second value so as to disable receipt of the specific packets when it is determined that the packet storm has occurred.

Another object of the disclosure is to provide a baseboard management controller (BMC) that is capable of implementing the above-mentioned method.

According to one embodiment of the disclosure, the BMS is included in a server, and includes:

a connection port for receiving network packets from a network;

a network queue buffer coupled to the connection port for storing the network packets therein; and

a processor coupled to the network queue buffer.

The processor is programmed to perform the steps of:

assigning a setting value included in firmware of the BMC regarding allowance for receipt of specific packets to a first value so as to enable receipt of specific packets via the connection port from the network, the specific packets being transmitted using a specific routing scheme;

determining whether a packet storm has occurred according to a number of the specific packets that are received by the server via the connection port; and

assigning the setting value to a second value so as to disable receipt of the specific packets when it is determined that the packet storm has occurred

Another object of the disclosure is to provide a server that includes the above-mentioned BMC.

### BRIEF DESCRIPTION OF THE DRAWINGS

Other features and advantages of the disclosure will become apparent in the following detailed description of the embodiment with reference to the accompanying drawings, of which:

FIG. 1 is a block diagram of an embodiment of a server, according to one embodiment of the disclosure; and

FIG. 2 is a flow chart of a method for interrupting a packet storm in the server, according to one embodiment of the disclosure.

### DETAILED DESCRIPTION

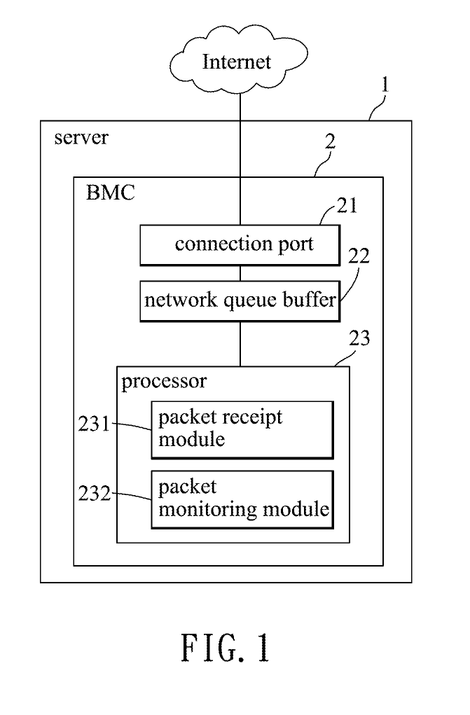

FIG. 1 illustrates a baseboard management controller (BMC) 2 included in a server 1, according to one embodiment of the disclosure. The BMC 2 is employed by the server 1 to communicate with a number of remote clients via a network (e.g., the Internet), and is employed by the server 1 to implement monitoring of the remote clients via the network.

The BMC 2 includes a connection port 21, a network queue buffer 22, a processor 23, and a non-transitory storage medium (not shown in the drawings) that stores firmware therein.

The connection port 21 is coupled to the network queue buffer 22, and serves as an interface between the remote clients and the network queue buffer 22. Is use, the connection port 21 is for receiving network packets from the network.

Specifically, when a network packet intended for the server 1 is transmitted via the network, the connection port 21 receives the network packet and stores the network packet in the network queue buffer 22.

The processor 23 is coupled to the network queue buffer 22, and includes a packet receipt module 231 and a packet monitoring module 232. In this embodiment, the packet receipt module 231 and a packet monitoring module 232 may be embodied using firmware or software application executed by the processor 23.

The packet receipt module 231 is controlled by the packet monitoring module 232 to switch between an enabled mode and a disabled mode. In the enabled mode, the packet receipt module 231 controls the network queue buffer 22 to store the received network packets. In the disabled mode, the packet receipt module 231 controls the network queue buffer 22 to drop specific packets that are received via the connection port 21 and that are transmitted using a specific routing scheme.

The packet monitoring module 232 is programmed to determine whether a packet storm has occurred during a predetermined time period.

It is noted that the term “packet storm” indicates that a number of the specific packets received within the predetermined time period is larger than a threshold number. Each of the specific packets may be one of a broadcast packet and a multicast packet. Namely, the network packet that is transmitted to the server 1 using the specific routing scheme, such as multicast (transmitted to a number of selected destinations) or broadcast (transmitted to all possible destinations), is considered a specific packet. Those network packets are relatively more likely to be used for malicious purposes such as distributed denial-of-service (DDoS) attacks.

When such a condition occurs, the BMC 2 may risk excessive traffic and other undesired effects if all of the network packets received are to be stored and processed. Accordingly, the packet monitoring module 232 is programmed to control the packet receipt module 231 to switch to the disabled mode, thereby blocking some traffic toward the BMC 2 for certain amount of time or a predetermined cool-down duration. It is noted that the switching of the BMC 2 between the enabled mode and the disabled mode is implemented by the processor 23 according to a setting value included in the firmware of the BMC 2 and regarding allowance for receipt of specific packets.

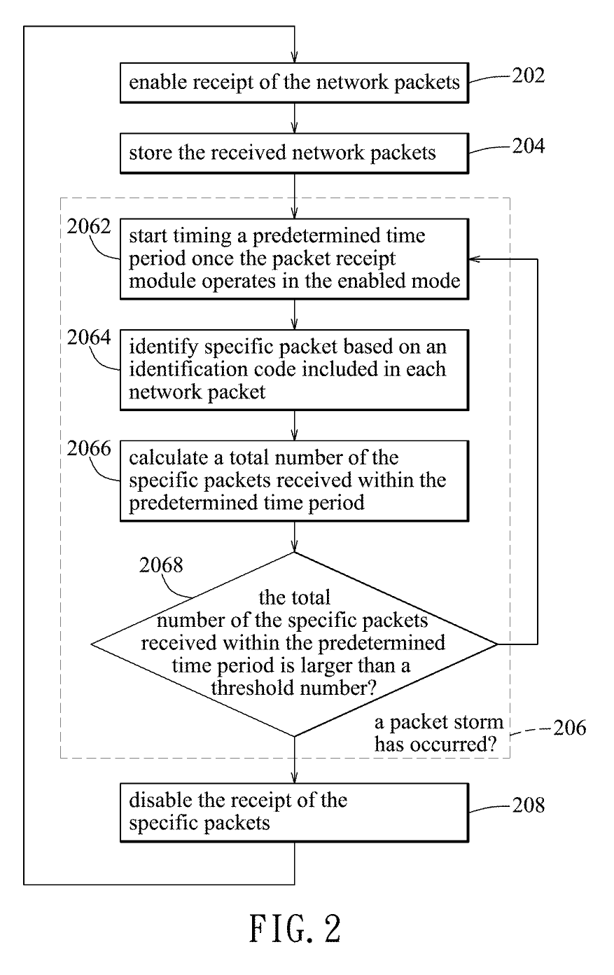

Specifically, in this embodiment, when it is detected that the setting value equals a first value (e.g., a binary number 1), the BMC 2 is switched to the enabled mode. On the other hand, when it is detected that the setting value equals a second value (e.g., a binary number 0), the BMC 2 is switched to the disabled mode. FIG. 2 is a flow chart illustrating steps of a method for interrupting a packet storm in the server 1, according to one embodiment of the disclosure. The method is implemented by the processor 23 of the BMC 2.

In step 202, the packet monitoring module 232 of the processor 23 assigns the setting value regarding allowance for receipt of specific packets to the first value, so as to enable receipt of the network packets via the network. That is to say, the packet receipt module 231 is controlled by the packet monitoring module 232 to operate in the enabled mode, and the network packets will be received via the connection port 21.

In step 204, the packet receipt module 231 in the enabled mode controls the network queue buffer 22 to store the received network packets.

In step 206, the packet monitoring module 232 determines whether a packet storm has occurred, according to the network packets received by the server 1. Note that steps 204 and 206 may essentially begin simultaneously.

Specifically, step 206 includes the following sub-steps.

In sub-step 2062, the packet monitoring module 232 starts timing a predetermined time period once the packet receipt module 231 operates in the enabled mode. This may be implemented by a timer (not depicted in the drawings) included in the processor 23.

In sub-step 2064, the packet monitoring module 232 identifies any specific packet (i.e., the broadcast packet or the multicast packet) from the network packets stored in the network queue buffer 22, based on an identification code included in each of the network packets.

In sub-step 2066, the packet monitoring module 232 calculates a total number of the specific packets received within the predetermined time period (i.e., during the entire duration of the predetermined time period). In this embodiment, the predetermined time period is set to be 330 milliseconds.

In sub-step 2068, the packet monitoring module 232 determines whether the total number of the specific packets received within the predetermined time period is larger than a threshold number. In this embodiment, the threshold number is 1650. That is to say, the packet monitoring module 232 determines, at a frequency of roughly three times a second, whether a transmission rate of the specific packets to the server 1 is larger than roughly 5000 packets per second.

When the determination made in sub-step 2068 is affirmative (i.e., the number of the specific packets is larger than the threshold number, and it is determined that a packet storm has occurred), the flow proceeds to step 208. Otherwise, the flow goes back to sub-step 2062 to perform another determination after another 330 milliseconds (i.e., the predetermined time period) has elapsed.

In other embodiments, the packet monitoring module 232 may accumulate an accumulated number of the specific packets that are received after sub-step 2062, and determine that the packet storm has occurred once the accumulated number of the specific packets is larger than the threshold number at any time point within the predetermined time period. In this case, when the accumulated number of the specific packets is not larger than the threshold number, sub-step 2062 is repeated. Otherwise, the flow proceeds to step 208.

In step 208, the packet monitoring module 232 assigns the setting value to a second value, so as to disable the receipt of the specific packets. That is to say, the packet receipt module 231 is switched to the disabled mode, and the specific packets intended for the server 1 will be dropped (i.e., not stored in the network queue buffer 22).

The packet receipt module 231 is configured to remain in the disabled mode for a predetermined cool-down duration, during which the BMC 2 disables the receipt of the specific packets. On the other hand, packets that are not considered the specific packets (e.g., data packets received via Dynamic Host Configuration Protocol (DHCP)) may be allowed to be received and to be stored in the network queue buffer 22 during the predetermined cool-down duration. In this embodiment, the predetermined cool-down duration is one second.

Afterward, the flow goes back to step 202, and the packet monitoring module 232 controls the packet receipt module 231 to operate in the enabled mode so as to enable the receipt of the network packets via the network again.

To sum up, the method and the BMC 2 as described in the disclosure provide a way to filter out the specific packets that are transmitted to the BMC 2 in the server 1 using the specific routing scheme, and therefore are capable of maintaining the BMC 2 in a normal operational state even when there is a packet storm.

It is noted that, in the embodiments of the disclosure, the method is implemented by the BMC 2, which is included in the server 1 instead of being an external device. This may result in the effect that the detailed setting of the method (e.g., the determination of the time period, the threshold number, the cool-down duration, etc.) may be done by a user interacting directly with the server 1.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for interrupting a packet storm in a server, the method to be implemented by a baseboard management controller (BMC) included in the server and comprising the steps of:
a) assigning a setting value included in firmware of the BMC regarding allowance for receipt of specific packets to a first value so as to enable receipt of specific packets from a network, the specific packets being transmitted using a specific routing scheme;
b) determining whether a packet storm has occurred according to a number of the specific packets that are received after step a); and
c) assigning the setting value to a second value so as to disable receipt of the specific packets when it is determined that the packet storm has occurred.

2. The method of claim 1, the BMC including a queue buffer, wherein said method further comprises, after step a), the step of storing network packets received by the server in the queue buffer.

3. The method of claim 2, wherein step b) includes
identifying the specific packets from the network packets which are stored in the queue buffer, based on an identification code included in each of the network packets;
calculating a total number of the specific packets received within a predetermined time period; and
when it is determined that the total number of the specific packets received within the predetermined time period is larger than a threshold number, determining that the packet storm has occurred.

4. The method of claim 3, wherein each of the specific packets is one of a broadcast packet and a multicast packet.

5. The method of claim 3, wherein the predetermined time period is 330 milliseconds.

6. The method of claim 1, wherein, in step c), the BMC disables receipt of the specific packets for a predetermined cool-down duration.

7. The method of claim 6, further comprising the step of repeating steps a) to c) after the predetermined cool-down duration has elapsed.

8. The method of claim 6, wherein the predetermined cool-down duration is one second.

9. A baseboard management controller (BMC) included in a server, comprising:
a connection port for receiving network packets from a network;
a network queue buffer coupled to said connection port for storing the network packets therein;
a non-transitory storage medium that stores firmware therein, the firmware including a setting value regarding allowance for receipt of specific packets; and
a processor coupled to said network queue buffer, wherein said processor is programmed to perform the steps of:
assigning the setting value to a first value so as to enable receipt of specific packets via said connection port from the network, the specific packets being transmitted using a specific routing scheme;
determining whether a packet storm has occurred according to a number of the specific packets that are received by the server via said connection port; and
assigning the setting value to a second value so as to disable receipt of the specific packets when it is determined that the packet storm has occurred.

10. The BMC of claim 9, wherein said processor determines whether a packet storm has occurred by:
identifying the specific packets from the network packets which are stored in said network queue buffer, based on an identification code included in each of the network packets;
calculating a total number of the specific packets received within a predetermined time period; and
when it is determined that the total number of the specific packets received within the predetermined time period is larger than a threshold number, determining that the packet storm has occurred.

11. The BMC of claim 10, wherein each of the specific packets is one of a broadcast packet and a multicast packet.

12. The BMC of claim 10, wherein the predetermined time period is 330 milliseconds.

13. The BMC of claim 9, wherein, when it is determined that the packet storm has occurred, said processor disables receipt of the specific packets for a predetermined cool-down duration.

14. The BMC of claim 13, wherein the predetermined cool-down duration is one second.

15. A server comprising a baseboard management controller (BMC), said BMC including:
a connection port for receiving network packets from a network;
a network queue buffer coupled to said connection port for storing the network packets therein;
a non-transitory storage medium that stores firmware therein, the firmware including a setting value regarding allowance for receipt of specific packets; and
a processor coupled to said network queue buffer, wherein said processor is programmed to perform the steps of:
assigning the setting value to a first value so as to enable receipt of specific packets via said connection port from the network, the specific packets being transmitted using a specific routing scheme;
determining whether a packet storm has occurred according to a number of the specific packets that are received after said processor enables receipt of the network packets; and
assigning the setting value to a second value so as to disable receipt of the specific packets when it is determined that the packet storm has occurred.

16. The server of claim 15, wherein said processor determines whether a packet storm has occurred by:
identifying the specific packets from the network packets which are stored in said network queue buffer, based on an identification code included in each of the network packets;
calculating a total number of the specific packets received within a predetermined time period; and
when it is determined that the total number of the specific packets received within the predetermined time period is larger than a threshold number, determining that the packet storm has occurred.

17. The server of claim 16, wherein the specific routing scheme is one of broadcast and multicast.

18. The server of claim 16, wherein the predetermined time period is 330 milliseconds.

19. The server of claim 15, wherein, when it is determined that the packet storm has occurred, said processor disables receipt of the specific packets for a predetermined cool-down duration.

20. The server of claim 19, wherein the predetermined cool-down duration is one second.
